(19) United States
(12) Patent Application Publication
(10) Pub. No.: US 2009/0166241 A1
(43) Pub. Date: Jul. 2, 2009

(54) Container from recycled material

(75) Inventor: James Lee, Old Tappan, NJ (US)

Correspondence Address: FROMMER LAWRENCE & HAUG, 745 FIFTH AVENUE- 10TH FL., NEW YORK, NY, 10151, US

(73) Assignee: Organize-it-All Inc.

(21) Appl. No.: 12/005,987

(22) Filed: Dec. 28, 2007

(51) Int. Cl. B65D 85/00; B65D 8/04; B29C 53/00

(52) U.S. Cl. 206/524.6; 220/676; 264/239

(57) ABSTRACT

An environmentally friendly container, made from recycled material. The container can be made with post-consumer waste paper. A coating can be applied to the container to enhance moisture resistance. The recycled material can include an additive for structural integrity and/or moisture resistance.

### BACKGROUND OF THE INVENTION

1. Field of the Invention

This invention relates generally to containers fabricated using recycled material. The container may be used, for example, as a wastebasket, garbage can, tub, flower pot, or other type of receptacle. More particularly, this invention relates to a container made from recycled paper.

2. Description of Related Art

For decades, containers have been made out of plastic. Plastic is useful for making containers, such as wastebasket, tub, box, etc. Particularly, wastebaskets are usually made with plastic, which conveniently holds both dry and wet garbage. Although other materials such as metal or wood could be used, they are susceptible to rust or rot and other effects of weather or garbage. Also, such material could be heavy and costly to manufacture. On the other hand, plastic is durable, lightweight, easy to fabricate into different designs, and economical to manufacture. However, despite many desirable characteristics, plastic has harmful drawbacks. Plastics, such as polystyrene, polyvinyl chloride (often called PVC), or nylon, are synthetic chemical substances that do not degrade easily. When they do degrade, they potentially generate and release harmful substances into the environment. Thus, in recent years proper disposal of plastic has become a foremost concern.

### SUMMARY OF THE DISCLOSURE

In one aspect of the invention a container includes a body portion in the shape of a frustum of a cone or pyramid, having a top end and a bottom end. A bottom portion is formed on the body portion and closes the bottom end. The top end is open. The body portion and the bottom portion are made of recycled material. In another aspect of the invention a method of making a container comprises forming a body portion in the shape of a frustum of a cone or pyramid, having a top end and a bottom end. The bottom end is closed by forming a bottom portion to the body portion at the bottom end. In one or more aspects this invention has certain advantages, including water resistance, maintenance of structure upon impact, and functionality in indoor and outdoor environments.

### BRIEF DESCRIPTION OF THE DRAWINGS

FIG. 1 illustrates an embodiment of a container according to the present disclosure;

FIG. 2 illustrates a bottom view of an embodiment of a container according to the present disclosure;

FIG. 3 illustrates a side view of an embodiment of a container according to the present disclosure; and

FIG. 4 illustrates an embodiment of a container according to the present disclosure, with through holes on the side wall.

### DETAILED DESCRIPTION

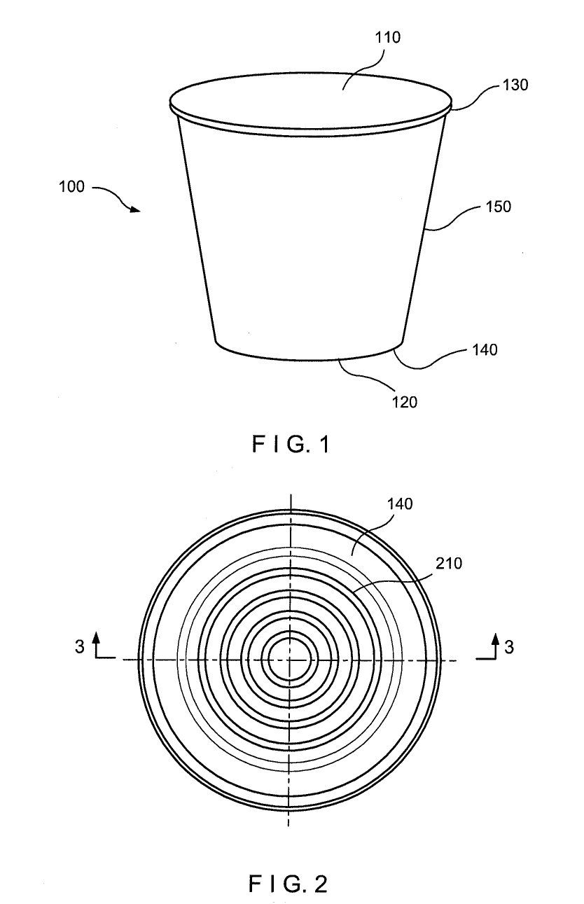

FIG. 1 illustrates an embodiment of a container 100 according to the present disclosure.

Container 100 is made from recycled material and may be in the shape of an upside-down frustum of a cone, pyramidical or tubular shape. Container 100 has an open end 110 at a top end, and is closed at a bottom end 120. Bottom end 120 is closed by means of a bottom portion 140. A body portion 150 can form an angle with a bottom portion 140 at the closed end 120, forming a container that can receive and store garbage or other material. In an implementation, bottom portion 140 may have openings therein to enable passage of fluid through the bottom portion 140. Container 100 can be made to resist water or moisture, or made with an additive to improve structural integrity. Open end 110 can have a rolled lip 130 instead of a sharp edge. Rolled lip 130 may be used to pick up the container or to avoid injury to personnel.

FIG. 2 illustrates a bottom view of the embodiment shown in FIG. 1. The closed end, bottom portion 140 of container 100, can have a skid-resistant profile. One embodiment of a skid-resistant profile is one or more concentric ridges or grooves 210 in bottom portion 140.

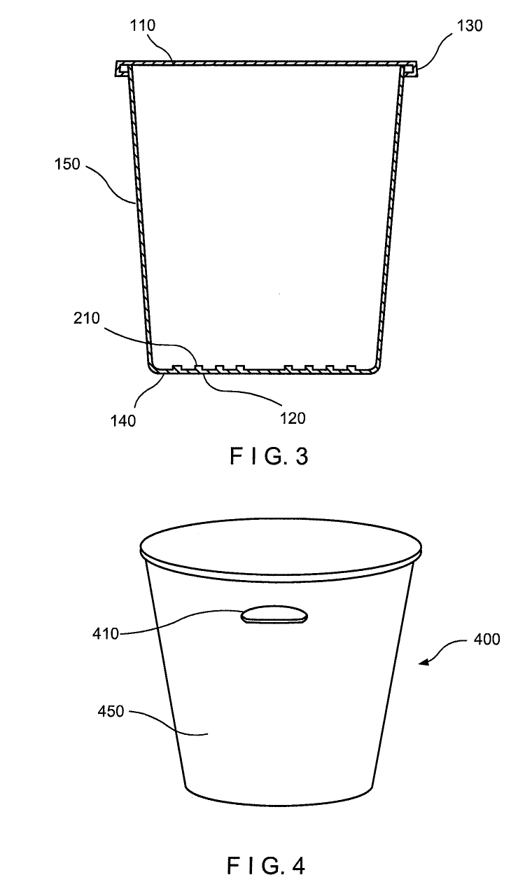

FIG. 3 illustrates a side view of the embodiment shown in FIG. 1, showing rolled lip 130 and upper edge of skid-resistant groove 210.

FIG. 4 illustrates another embodiment, wherein a container 400 has one or more through holes 410 in a sidewall 450. Through hole 410 may be shaped to enable a user to pick up the container.

Recycled material can be post-consumer waste paper. Recycling conserves limited landfill space, and using recycled material in lieu of plastic achieves the dual benefit of limiting plastic waste generation and recycling. A container according to this disclosure may be as durable, functional, and economical as plastic or other type of container, and is also environmentally friendly.

Other embodiments are within the scope of the following claims.

What is claimed is:

1. A container comprising:
a body portion in the shape of a frustum of a cone or pyramid, having a top end and a bottom end;
a bottom portion formed on the body portion and closing the bottom end, wherein the top end is open, and wherein the body portion and the bottom portion are made of recycled material.

2. A container as recited in claim 1, wherein the recycled material is paper.

3. A container as recited in claim 1, wherein the recycled material is water resistant.

4. A container as recited in claim 1, comprising a water resistant coating covering at least an interior surface of the body portion and the bottom portion.

5. A container as recited in claim 1, wherein the recycled material includes one or more additives for structural integrity.

6. A container as recited in claim 2, wherein the recycled material includes one or more additives for structural integrity.

7. A container as recited in claim 3, wherein the recycled material includes one or more additives for structural integrity.

8. A container as recited in claim 1, wherein the top end of the body portion has a rolled lip.

9. A container as recited in claim 2, wherein the top end of the body portion has a rolled lip.

10. A container as recited in claim 3, wherein the top end of the body portion has a rolled lip.

11. A container as recited in claim 5, wherein the top end of the body portion has a rolled lip.

12. A container as recited in claim 1, wherein the bottom portion has a skid-resistant profile.

13. A container as recited in claim 12, wherein the skid-resistant profile is one or more grooves.

14. A container as recited in claim 1, wherein the bottom portion has one or more openings.

15. A container as recited in claim 12, wherein the bottom portion has one or more openings.

16. A container as recited in claim 1, wherein the body portion has one or more through holes.

17. A container as recited in claim 12, wherein the body portion has one or more through holes.

18. A container as recited in claim 15, wherein the body portion has one or more through holes.

19. Method of making a container comprising:
forming a body portion in the shape of a frustum of a cone or pyramid, having a top end and a bottom end;
closing the bottom end by forming a bottom portion to the body portion at the bottom end.
